(19) United States
(12) Patent Application Publication
(10) Pub. No.: US 2012/0197971 A1
(43) Pub. Date: Aug. 2, 2012

(54) ENHANCED WEB-BROWSING SYSTEM AND METHOD

(75) Inventor: YUNJIAN JIANG, San Jose, CA (US)

(73) Assignee: SHIARNG LLC, San Jose, CA (US)

(21) Appl. No.: 13/018,453

(22) Filed: Feb. 1, 2011

(51) Int. Cl. G06F 15/16

(52) U.S. Cl. 709/203

(57) ABSTRACT

A web-browsing system is provided. The web-browsing system includes a web-server coupled to a computer network to provide web services via the computer network. The web-browsing system also includes a client computer coupled to the web-server via the computer network to enable a user of the client computer to browse a web page accessible via the computer network. Further, a client web-browsing functionality is statically partitioned between the client computer and the web-server. The web-server is configured to perform predetermined computational tasks for the client computer to process user inputs from the client computer and web page contents requested by the client computer, and to send processed results back to the client computer. Further, the client computer is configured to load web resources and to display the web page to the user according to the processed results from the web-server.

### FIELD OF THE INVENTION

The present invention generally relates to Internet technologies and, more particularly, to the methods and systems for improving web-browsing architecture and implementations.

### BACKGROUND

Web-browsers are software applications that fetch multi-media contents from remote web-servers connected with the Internet, or World Wide Web. A browser typically is designed as a stand-alone software program running on a client computer, such as a personal computer, for a single user.

The web-browsing often starts with a Uniform Resource Identifier (URI) given by the user, which may be a web page, image, video, or other piece of information. The most commonly used URI starts with “http:”, which identifies a resource to be retrieved over the Hypertext Transfer Protocol (HTTP). The information is fetched from remote web-servers to local memory.

A web page is usually written in Hypertext Markup Language (HTML) format, which is then parsed (compiled) into two-dimensionally structured information by the layout engine. When a web page contains embedded scripts, such as a Java script, additional script parsing is performed, and the parsing result is incorporated back into the web page. The final step is rendering, which properly displays contents such as fonts and images on the personal computer screen.

Thus, modern web pages often contain rich interactive contents implemented via various technologies and web-browsers become more and more complex, and client computer running web-browsers also requires increasingly complex hardware/software and sometime discourages unsophisticated users.

The disclosed methods and systems are directed to solve one or more problems set forth above and other problems.

### BRIEF SUMMARY OF THE DISCLOSURE

One aspect of the present disclosure includes a web-browsing system. The web-browsing system includes a web-server coupled to a computer network to provide web services via the computer network. The web-browsing system also includes a client computer coupled to the web-server via the computer network to enable a user of the client computer to browse a web page accessible via the computer network. Further, a client web-browsing functionality is statically partitioned between the client computer and the web-server. The web-server is configured to perform predetermined computational tasks for the client computer to process user inputs from the client computer and web page contents requested by the client computer, and to send processed results back to the client computer. Further, the client computer is configured to load web resources and to display the web page to the user according to the processed results from the web-server.

Another aspect of the present disclosure includes a method for a client computer. The client computer is coupled to a web-server via a computer network to provide a client web-browsing functionality statically partitioned between the client computer and the web-server. The method includes initializing local hardware and software components and sending an initialization request to the web-server. The method also includes establishing a browser session with the web-server corresponding to a web page based on a response to the initialization request from the web-server, and receiving processed data associated with the web page from web-server. Further, the method includes, when the processed data include texts, extracting corresponding fonts from a local font library and displaying the texts on a computer screen of the client computer. The method also includes, when the processed data include geometric drawing information, regenerating corresponding geometry shapes locally on the client computer and displaying the geometry shapes on the computer screen of the client computer.

Another aspect of the present disclosure includes a method for a web-server. The web-server is coupled to a client computer via a computer network to provide a client web-browsing functionality statically partitioned between the client computer and the web-server. The method includes receiving an input from the client computer, and determining whether the input is an initialization request or a request for an existing browser session. The method also includes searching any stored browser session associated with the client computer when the web-server determines that the input is an initialization request from the client computer. The method also includes recovering a stored browser session such that the client computer continues from the recovered stored browser session when the web-server finds the stored browser session associated with the client computer. Further, the method includes creating a new browser session for client computer when the web-server does not find the stored browser session associated with the client computer.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary network environment incorporating certain aspects of the disclosed embodiments;

FIG. 2 illustrates an exemplary web-browser functionality partition consistent with the disclosed embodiments;

FIG. 3 illustrates an exemplary client computer consistent with the disclosed embodiments;

FIG. 4 illustrates an exemplary web-server consistent with the disclosed embodiments;

FIG. 5 illustrates an exemplary software framework on a web-server consistent with the disclosed embodiments;

FIG. 6 illustrates an exemplary client computer operation process consistent with the disclosed embodiments; and

FIG. 7 illustrates an exemplary web-server operation process consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

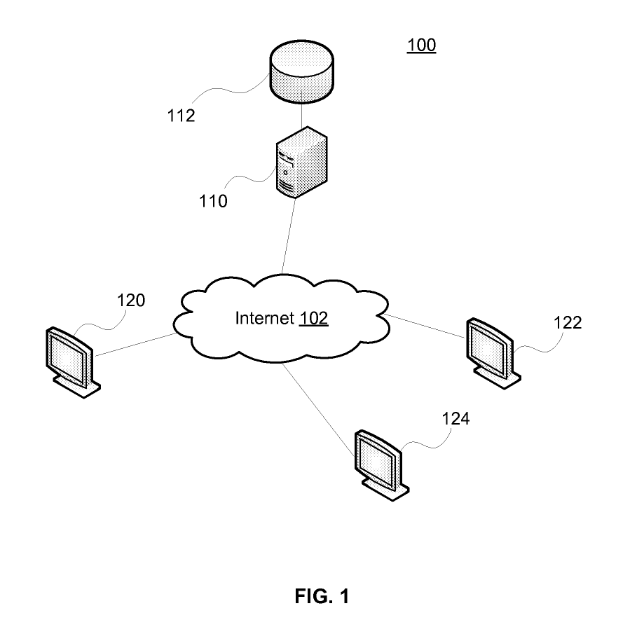

FIG. 1 illustrates an exemplary network environment incorporating certain aspects of the disclosed embodiments. As shown in FIG. 1, network environment 100 may include the Internet 102, a web-server 110, a database server 112, and client computers 120, 122, and 124. Other components may be added and certain devices may be removed without departing from the principles of the disclosed embodiments. The Internet 102 may include any private and public computer networks interconnected using the standard transport control protocol/internet protocol (TCP/IP). Internet 102 may carry a large number of services over IP, such as the inter-linked hypertext documents of the world-wide-web (WWW) and hypertext transfer protocol (HTTP).

Web-server 110 may provide Internet-based web services. Web-server 110 may include any appropriate computer servers, software, and databases so as to provide various computing resources and web-browsing related services. A database server 112 may also be provided to web-server 110 to store any appropriate data to be used by web-server 110, such as user data, configuration data, and network data, etc. Other servers may also be included.

Further, client computers 120, 122, and 124 may be provided to enable users of client computers 120, 122, and 124 to access web pages over the Internet 102. Although only three client computers are shown in FIG. 1, any number of client computers may be included. Client computers 120, 122, and 124 may include any appropriate types of computers operated by users to perform web-browsing on web pages provided by computers or servers on the Internet 102. For example, client computers 120, 122, and 124 may include desktop computers, notebook computers, tablets, smart phones, and other types of computing platforms and software programs.

In certain embodiments, client computers 120, 122, and 124 may be provided, together with web-server 110, to implement an enhanced web-browsing architecture. A client computer (e.g., 120) may be a customized computer to support a simplified web-browsing structure, e.g., a customized hardware device that does web-browsing only.

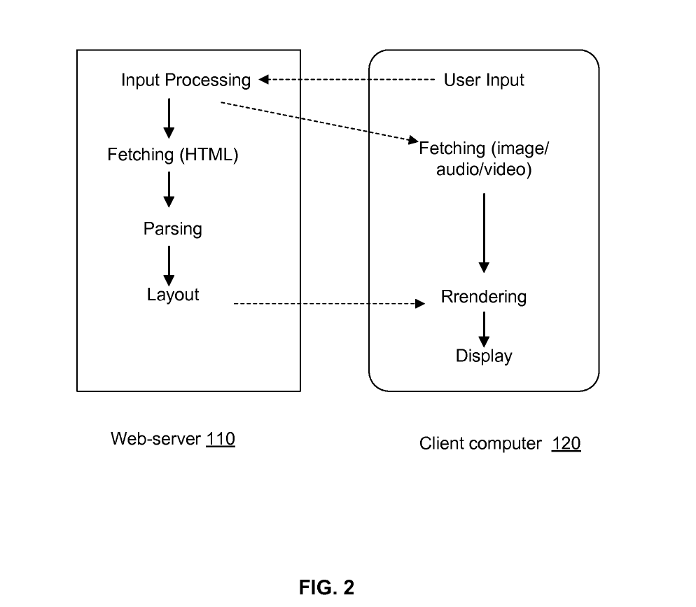

More particularly, client computer 120 may include a web-browsing platform that only supports a portion of web-browser functionality while the remaining portion of the web-browser functionality is supported by web-server 110. The web-browser functionality, as used herein, may refer to a web-browser's functions for bring information resources to the user, including retrieving, parsing, laying out, rendering, and displaying the information resources, and for interacting with the user using web browser software or plug-in software applications. For example, the web-browser functionality may refer to client-side web-browsing functions in a normal personal computer for accessing web pages provided on the Internet 102. Thus, the entire web-browser functionality is distributed between client computer 120 and web-server 110, and web-server 110 and client computer 120 may comprise a web-browsing system when performing the partitioned web-browser functionality together. FIG. 2 illustrates an exemplary allocation of web-browser functionality consistent with the disclosed embodiments.

As shown in FIG. 2, the web-browser functionality is statically partitioned between client computer 120 and web-server 110. Statically partitioning, as used herein, refers to a pre-determined partition made before the run-time by hardware, by user configuration, or by both. For example, those web-browser tasks that require intensive computation and complex resource scheduling may be partitioned or allocated to web-server 110; while those web-browser tasks that are bandwidth intensive but easy to implement in hardware, such as user-input capturing and rendering texts, images, audio, and video, etc., may be allocated to client computer 120.

More particularly, for browsing a web page using both web-server 110 and client computer 120, as shown in FIG. 2, client computer 120 may capture user input and web-server 110 may perform input processing. Client computer 120 may obtain results of input processing from web-server 110, and performs fetching web page contents such as images, audio, and video. On the other hand, web-server 110 may perform fetching certain to-be-processed web page contents, such as HTML documents, and scripts. Web-server 110 may further process or parse the HTML document or texts to generate corresponding page contents and also generate a layout for rendering the page contents. The page contents requested by client computer 120 layout is then sent back to client computer 120, and client computer 120 further performs rendering the web page and finally displays the rendered web page to the user.

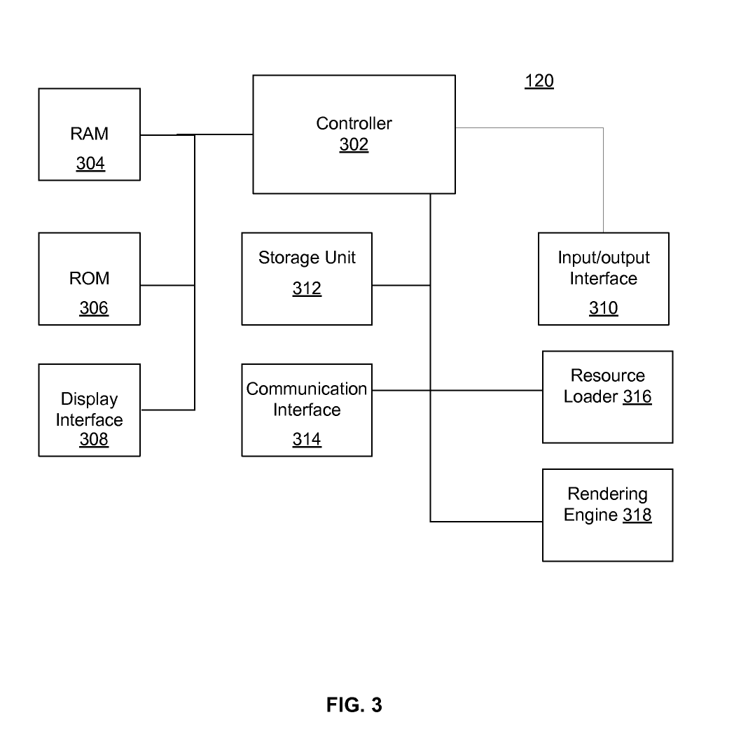

Other partitioning configurations may also be used. The partitioning of the web-browser functionality between client computer 120 and web-server 110 is made such that client computer 120 may act as a web-browser-enhanced computer terminal for web-server 110. However, the communication bandwidth requirement between web-server 110 and client computer 110 is relatively low, because bandwidth-intensive tasks, such as fetching page contents, are allocated to client computer 120. Thus, such arrangement allows web-server 110 to serve a large number of client computers 120 simultaneously. FIG. 3 illustrates an exemplary block diagram of a client computer consistent with the disclosed embodiments.

As shown in FIG. 3, client computer 120 may include a controller 302, a random access memory (RAM) unit 304, a read-only memory (ROM) unit 306, a display interface 308, an input/output interface unit 310, a storage unit 312, a communication interface 314, a resource loader 316, and a rendering engine 318. Other components may be added and certain devices may be removed without departing from the principles of the disclosed embodiments.

Controller 302 may include any appropriate type of graphic processing unit (GPU), general-purpose microprocessor, digital signal processor (DSP), microcontroller, and application specific integrated circuit (ASIC), etc. Controller 302 may execute sequences of computer program instructions to perform various processes associated with client computer 120. The computer program instructions may be loaded into RAM 304 for execution by controller 302 from read-only memory 306. Controller 302 may control operation of client computer 120. For example, controller 302 may perform system flow control when communicating over Internet 102 or with web-server 110.

Display interface 308 may include any appropriate interface or display controller to control a computer monitor or a display device, such as a liquid crystal display (LCD) and other video display devices. Display interface 308 may support various video decoding formats (e.g., H264.8) and may also include frame buffers. Further, input/output interface 310 may be provided for a user or users to input information into client computer 120 or for the user or users to receive information from client computer 120. For example, input/output interface 310 may include any appropriate input device, such as a remote control, a keyboard, a mouse, a microphone, a video camera or web-cam, an electronic tablet, a voice communication device, or any other optical or wireless input device. Input/output interface 310 may also include any appropriate output device, such as a speaker or any other audio device.

Storage unit 312 may include any appropriate storage device to store information used by client computer 120, such as a universal serial bus (USB) drive, a hard disk, a flash disk, an optical disk, a CR-ROM drive, a DVD or other type of mass storage media, or a network storage. Further, communication interface 314 may provide communication connections such that client computer 120 may be accessed remotely and/or communicate with web-server 110 or other systems through the Internet 102 or other communication networks via various communication protocols, such as TCP/IP and hyper text transfer protocol (HTTP). In operation, communication interface 314 may also communicate with web-server 110 to perform user authentication for establishing a web-browsing session.

Further, resource loader 316 may include any appropriate devices or modules to load information from a particular resource or resources via communication interface 314. For example, resource loader 316 may include various protocol handlers to obtain contents from the particular resource(s), such as images, audio, and video. Resource loader 316 may also include proper codec, such as audio decoders or video decoders, to load the contents properly. In addition, rendering engine 318 may include any appropriate devices or modules to generate a representation of texts, graphics, images, video, and/or audio of a web page according to a particular layout. The rendered contents may be further displayed on a display screen via display interface 308.

Part or all of above-listed components in client computer 120 may be implemented via hardware, software, or a combination of the hardware and the software. In certain embodiments, part or all of components in client computer 120 may be implemented via an ASIC such that client computer 120 may have a simple implementation and also have a significantly small size. For example, the partitioned client-browser functionality on client computer 120 may be implemented in the ASIC. Further, because the functionalities of client computer 120 are implemented in an ASIC, client computer 120 may only support a simple software structure without a formal operating system (OS), such as a commercial or equivalent OS. That is, client computer 120 may have to rely on web-server 110 for complex processing or computation tasks, such as parsing HTML and/or user input information processing.

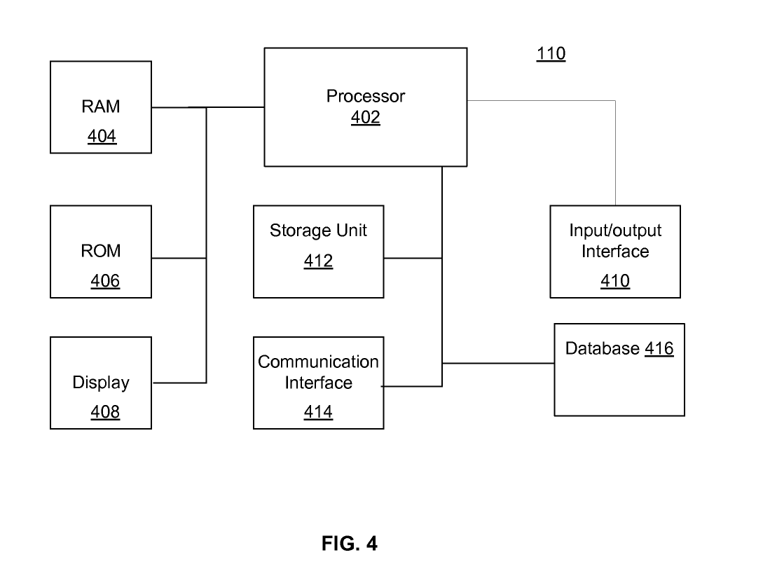

Web-server 110 may be implemented on any appropriate type of computer server system and may include one or more computer servers. FIG. 4 illustrates an exemplary web-server. As shown in FIG. 4, web-server 110 may include one or more processor 402, RAM 404, ROM 406, display interface 408, input/output interface 410, storage unit 412, communication interface 414, and database 416. In detail descriptions of these components are omitted because similar descriptions are explained in previous sections.

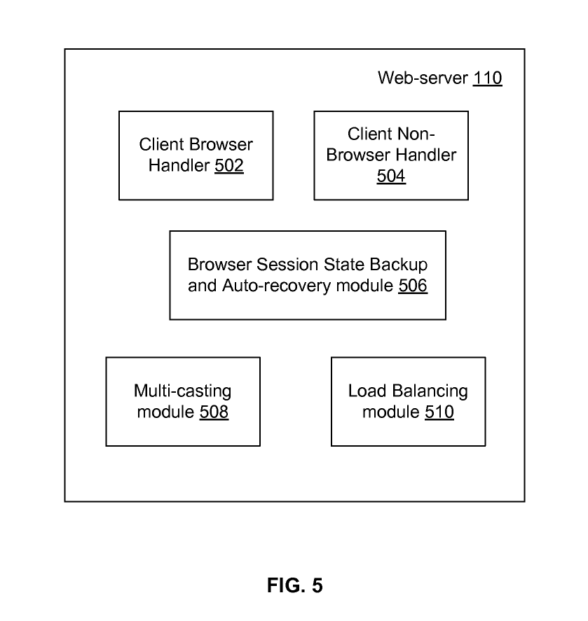

Web-server 110 may support a large number of client computers 120 for web services simultaneously based on the statically partitioned web-browser functionality. Certain software structures may be configured on web-server 110. FIG. 5 illustrates an exemplary software framework on web-server 110.

As shown in FIG. 5, the software framework of web-server 110 may include a client browser handler 502, a client non-browser handler 504, a browser session state backup and auto-recovery module 506, a multi-casting module 508, and a load balancing module 510. Other software components may also be included.

Client browser handler 502 may handle the tasks allocated to web-server 110 from the statically-partitioned client web-browser functionality. Client browser handler 502 may also be configured to run certain browser plug-in applications, such as document readers and media players. These browser plug-in applications are invoked by the user of client computer 120 on client computer 120, and the results and/or display information generated by web-server 110 are sent to client computers after the execution for display.

On the other hand, client non-browser handler 504 may handle the non-browser applications from client computer 120. Non-browser applications, as used herein, may include those internet-based plug-in applications that are not executed in a web-browser, such as Skype or other instant message applications. These applications may be supported by client computer 120 and invoked by the user of client computer 120 on client computer 120, but are executed on web-server 110 with the execution results sent to client computer 120 for display.

That is, as previously explained, client computer 120 may be lack of a commercial or equivalent OS such that client computer 120 may be unable to run these applications directly on client computer 120. Thus, these applications may be invoked from client computer 120 but are actually executed on web-server 110. When a browser or non-browser plug-in application is being executed on web-server 110, inputs and other data may be provided by client computer 120 to web-server 110, and results or the contents to be displayed are transmitted to client computer 120 and rendered by client computer 120 on client computer 120. Optionally, the user may invoke these applications by a drop-down menu on client computer 120 for available applications.

Further, browser session state backup and auto-recovery module 506 may include any appropriate software modules to maintain a browser session state of each client computer 120, including current loaded web-pages. Such information is stored on web-server 110 after the corresponding client computer disconnects from web-server 110, and the stored information is recovered for the corresponding client computer upon the client computer reconnects with web-server 110 after performing proper authentication with web-server 110.

Multi-casting module 508 may include any appropriate software module(s) to enable web-server 110 to connect a plurality of client computers to a same browser session on web-server 110, which may provide online learning capability for web-server 110. More specifically, each browser session may be identified with a unique ID. After proper authentication, different client computers may use the unique ID to connect to the same browser session associated with the unique ID. The multi-casting module 508 may multi-cast the session information to all connected client computers simultaneously such that all the connected client computers view the same web page. Multiple browser sessions may be created and maintained on web-server 110.

Further, load balancing module 510 may include any appropriate software and hardware module to perform load balancing for web-server 110. Requests from client computers go through load balancing unit 510, and load balancing unit 510 then routes the requests to a particular server in a server cluster of web-server 110 based on a current load situation of all servers in the server cluster. Other software and/or hardware modules may also included in web-server 110.

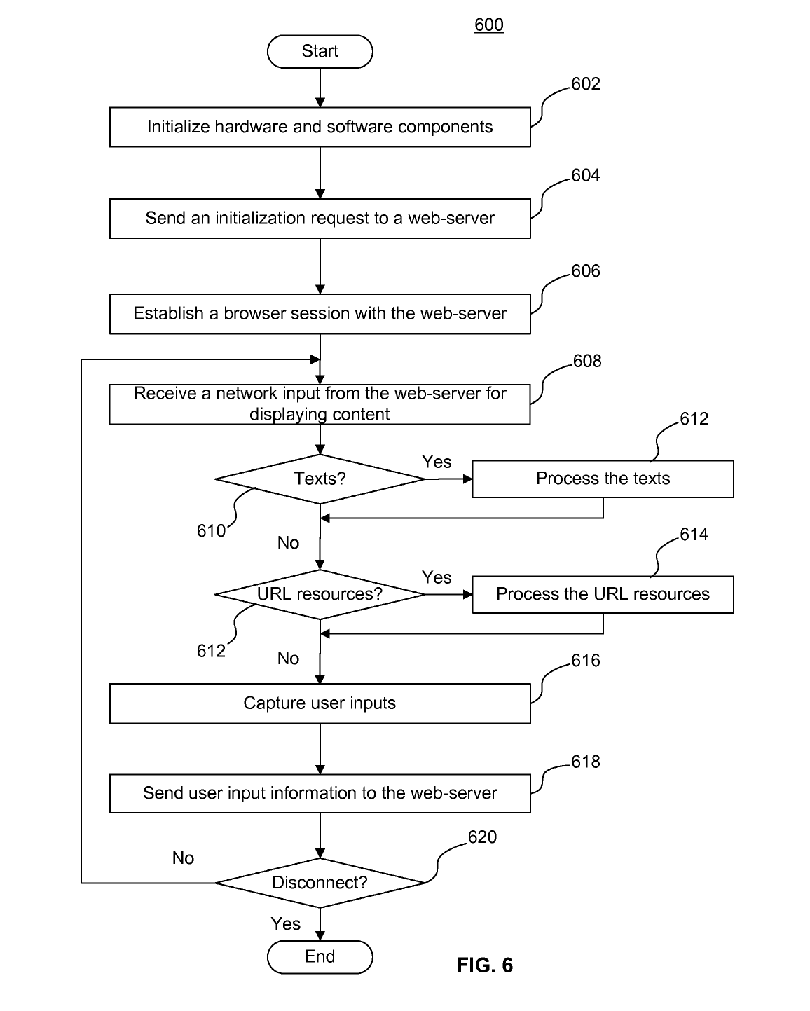

During operation, client computer 120 and web-server 110 may communicate with each and collaborate together to implement the partitioned web-browser functionality. FIG. 6 illustrates an exemplary operation process 600 on a client computer consistent with the disclosed embodiments.

As shown in FIG. 6, at the beginning, client computer 120 or controller 302 of client computer 120 may initialize local hardware components as well as software components (602). For example, client computer 120 may initialize network communication hardware and software such that client computer 120 is ready to perform the partitioned web-browser functionality with web-server 110. Client computer 120 may then send an initialization request to a web-server 110 (604). That is, client computer 120 may compose a browser session initialization request and send the initialization request to a server IP address associated with a predetermined or dynamically searched web-server 110.

Communications between client computer 120 and web-server 110 may optionally be encrypted, and compressed with a compression algorithm, such as the Lempel-Ziv (LZ) compression algorithm. The compressed communication data may be segmented into UDP/IP network packets and sent over the Internet 102 or other local or remote networks. Also optionally, before sending the initialization request, client computer 120 may first provide proper authentication to web-server 110 such that web-server 110 may authenticate the particular client computer 120 to allow further network communications.

Further, after receiving a response to the initialization request, client computer 120 establishes a browser session with web-server 110 (606). The browser session may be identified with a unique session ID. The session ID and other session information may be stored on client computer 120. Client computer 120 may then listen to a network input from web-server 110 for any information to be displayed on a local computer screen. When client computer 120 receives the network input from web-server 110 (608), client computer 120 may determine whether the received information includes texts (610).

If client computer 120 determines that the received information includes texts (610, yes), client computer 120 may process the texts (612). For example, client computer 120 may extract corresponding fonts from a local font library and may also display the texts on a computer screen using the fonts. If client computer 120 determines that the received information does not include texts (610, no), or after the texts are processed, client computer 120 may further determine whether the received information includes any resources identified by a uniform resource locator (URL) in an HTML document (612).

If client computer 120 determines that URL identified resources are included in the received information (612, yes), client computer 120 may process the URL resources (614). For example, when client computer 120 determines a static image with a URL, client computer 120 may directly load the static image from the remote server identified by the URL. The client computer 120 may also decode any encoded static images locally and display the images on the computer screen at corresponding pixel locations specified in the HTML document. Further, when client computer 120 determines that the processed data include geometric drawing information, client computer 120 may regenerate the geometry shapes locally on the client computer 120 and display the drawing on the computer screen of the client computer 120. When client computer 120 determines a video stream with a URL, client computer 120 may load the video stream from the remote server identified by the URL. Client computer 120 may also decode the video stream if it is encoded. For example, client computer 120 may support open standard video via HTML5 with hardware implementation of H.264.8. Client computer 120 may also display the video on the computer screen at corresponding pixel locations specified in the HTML document.

If client computer 120 determines that the received information does not include URL identified resources (612, no), or after the URL resources are processed, client computer 120 may continue capturing any user inputs (616). For example, client computer 120 may check for or listen to local user inputs from various input devices, such as a keyboard or a mouse, and may obtain user input information from the user inputs. User input information may include any appropriate information associated with a browser application, such as an event or a pixel location of the event. The user input information may also include a browser plug-in application being invoked by the user or a non-browser plug-in application being invoked by the user, together with any input or configuration information, etc.

After obtaining user input information (616), client computer 120 may send user input information to web-server 110 for processing (618). Client computer 120 may also determine whether the user wants to disconnect the browser session (620). If the user wants to disconnect the browser session (e.g., a power-off command) (620, yes), client computer 120 may disconnect the current browser session from web-server 110. On the other hand, if the user does not want to disconnect the browser session (620, no), client computer 120 may continue receiving or listening network inputs from web-server 110 from 608. Optionally, client computer 120 may also send to web-server 110 one or more synchronization packets every few seconds to indicate the client computer 120 is alive. Further, client computer 120 may encrypt and/or compress communication data exchanged between client computer 120 and web-server 120 using predetermined algorithms.

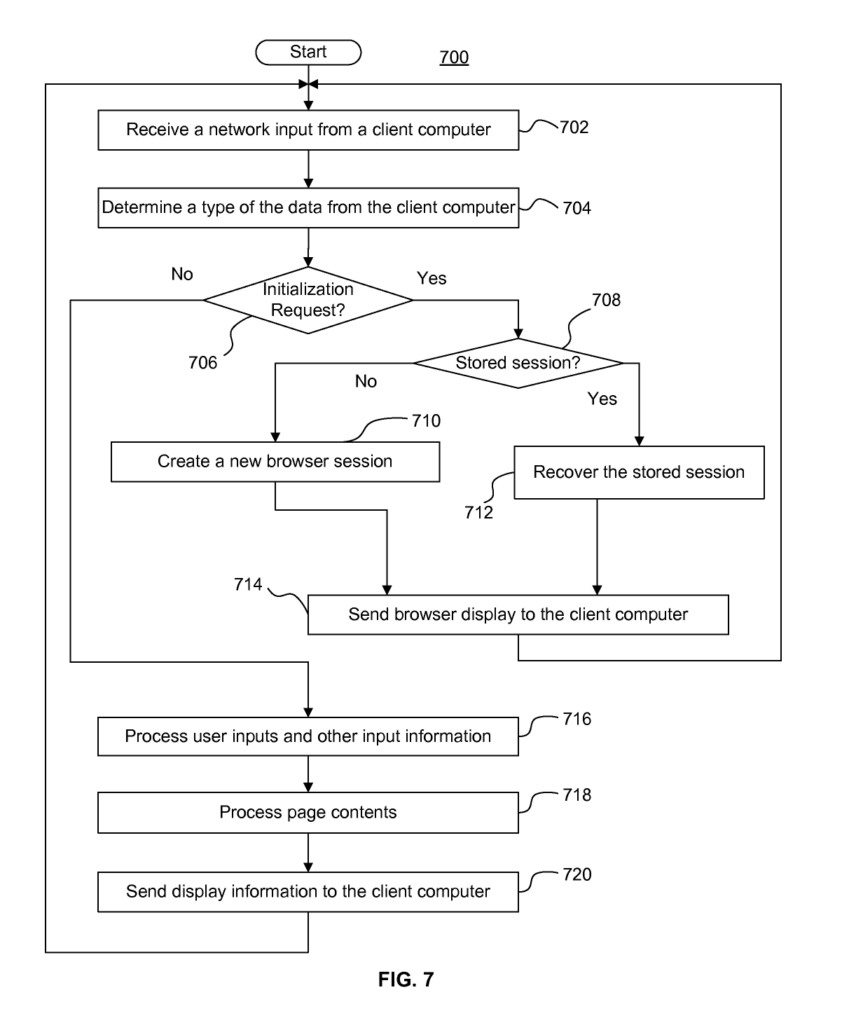

FIG. 7 illustrates an exemplary operation process 700 on a web-server consistent with the disclosed embodiments. As shown in FIG. 7, during operation, web-server 110 may listen to the network to receive a network input from a client computer 120 (702). Web-server 110 may receive the network input in the form of, for example, one or more client packets, and may determine a type of the received client packet (704). Web-server 110 may further determine whether the client packet is an initialization request from client computer 120 (706).

If web-server 110 determines that the client packet is an initialization request from client computer 120 (706, yes), web-server 110 may check whether there is any stored session associated with the client computer 120 (708). A stored session may refer to a previously established session between the client computer 120 and web-server 110, identified by a unique session ID, and then disconnected by the client computer 120 or web-server 110. If web-server 110 determines there is a stored session for the client computer 120 (708, yes), web-server 110 may recover the stored session such that the client computer 120 may continue from the stored browser session (712). For example, web-server 110 may retrieve session states, session data, and stored web pages, etc., from a dedicated storage space on web-server 110 associated with client computer 120 to restore the browser session. The unique session ID may also be used to identify the stored browser session. Other information may also be recovered.

If web-server 110 determines there is not a stored session for the client computer 120 (708, no), i.e., a new initialization request, web-server 110 may create a new browser session for client computer 120 (710). Web-server 110 may also allocate a storage space for each client computer for the web-browsing processing. The dedicated storage space for each client computer may also be used by a client computer to transfer to web-server 110 and store personal files (files from individual client computer 120 or from the user of the client computer 120). Further, web-server 110 may send any browser display to client computer 120 (714). The browser display may reflect a set of web pages associated with a restored browser session or a new browser session.

On the other hand, if web-server 110 determines that the client packet is not an initialization request from client computer 120 (706, no), web-server 110 may determine that the client packet is a request for an existing browser session. Web-server 110 may find the existing browser session using, for example, a session ID or other user input information. For the existing browser session, web-server 110 may process user inputs contained in the client packet (716). The user inputs may correspond to different applications. For example, the user inputs may corresponding to a web page the user is browsing, an interactive action the user is performing, a browser plug-in application being invoked, or a non-browser plug-in application being invoked, etc. The user input may also indicate a request for a file transfer. For example, client computer 120 may request to store a file on web-server 110 or to fetch a file on web-server 110. After determining the file transfer request from client computer 120, web-server 110 may store the file on a dedicated storage space for client computer 120 or may extract the request file from the dedicated storage space and send the extracted file to client computer 120. The file may be a personal file, which may refer to a local file on client computer 120 or a user file on client computer 120. In addition, the user input may indicate a read-only session request, i.e., a browser session that cannot be changed by the requesting client computer, and web-server 110 may send page contents of the web pages associated with the browser session and ignore any further request for changing a browser state from the requesting client computer 120. Furthermore, the user input from the client computer 120 may contain an input event from a user of the client computer 120. The input event may include entering an input to one or more scripts embedded in an HTML document, and sending a new request to a web server hosting the visiting web page, etc. After the input event is processed, web-server 110 may create corresponding layout changes in response to the user input from the client computer 120.

Further, based on the user inputs corresponding to the web page, web-server 110 may process page contents of the web page (718). For example, web-server 110 may fetch page contents and may parse an HTML document for the web page, and may also parse any script in the HTML document or embedded in the HTML document, such as any number of Java scripts, Perl scripts, and PHP scripts, etc. Web-server 110 may also create a layout for the web page and other display information to be used in rendering. The layout for the web page may identify geometry and location of a particular content to be displayed. Further, web-server 110 may send the display information to client computer 120 for rendering and display. Web-server 110 may repeat operation process 700 to communicate with a large number of client computers.

Optionally, web-server 110 may backup the sessions between web-server 110 and a plurality of client computers 120. For example, for each connected client computer 120, web-server 110 may backup or store the session as a stored session for later retrieval. The stored information may include any appropriate session information, such as the session ID, session states, session data, and associated web pages. Other information may also be included. The information may be stored in the allocated storage space for each client computer 120.

In addition, if the user inputs correspond to a browser plug-in application being invoked from client computer 120, web-server 110 may execute the browser plug-in application on web-server 110 and may send the results of the execution, with display information for the results, to client computer 120 for display. Further, if the user inputs correspond to a non-browser plug-in application being invoked from client computer 120, web-server 110 may execute the non-browser plug-in application on web-server 110 and send the results of the execution, with display information for the results, to client computer 120 for display.

The disclosed systems and methods may provide many advantageous web-browsing applications. For example, the disclosed decomposition of computing and communication requirement of web-browsing in a client-server architecture, such that web-browsing can be realized at a large number of inexpensive client computers while supported by a limited number of web-servers. Further, the computing power of the web-server may be better exploited using high Internet-bandwidth of the client computers.

The disclosed systems and methods may be used in various industries. For example, universities and high-schools may deploy the enhanced web-browsing systems for student learning, libraries may deploy the enhanced web-browsing systems for book queries, network router equipment manufacturers may include the enhanced web-browsing functionality in their routers, and TV manufacturers may include the enhanced web-browsing functionality in their TV sets. Other advantageous applications are obvious to those skilled in the art.

What is claimed is:

1. A web-browsing system, comprising:
a web-server coupled to a computer network to provide web services via the computer network; and
a client computer coupled to the web-server via the computer network to enable a user of the client computer to browse a web page accessible via the computer network,
wherein:
a client web-browsing functionality is statically partitioned between the client computer and the web-server;
the web-server is configured to perform predetermined computational tasks for the client computer to process user inputs from the client computer and web page contents requested by the client computer, and to send processed results back to the client computer; and
the client computer is configured to load web resources and to display the web page to the user according to the processed results from the web-server.

2. The web-browsing system according to claim 1, wherein:
the partitioned web-browsing functionality is implemented in an application specific integrated circuit (ASIC) on the client computer without a formal operating system (OS).

3. The web-browsing system according to claim 1, wherein:
the web-server is further configured to connect a plurality of client computers and to hold a browser session common to the plurality of client computers such that the plurality of client computers simultaneously display a same web-page associated with the browser session.

4. The web-browsing system according to claim 3, wherein:
the web-server allocates a separate storage space for each of the plurality of client computers for storing session data and personal files.

5. The web-browsing system according to claim 1, wherein:
the web-server includes a browser application module configured to execute a browser plug-in application for the client computer, the browser plug-in application being invoked from the client computer.

6. The web-browsing system according to claim 1, wherein:
the web-server includes a non-browser application module configured to execute a non-browser plug-in application for the client computer, the non-browser plug-in application being invoked from the client computer.

7. The web-browsing system according to claim 1, wherein the web-server is further configured to:
parse an HTML document associated with the web page to generate web page contents corresponding to the HTML document;
parse at least one of a Java script, a Perl script, and a PHP script contained in the HTML document; and
send the web page contents corresponding to the HTML document and results from parsing the at least one script to the client computer.

8. The web-browsing system according to claim 1, wherein:
the web page resources includes uniform resource locator (URL) identified resources containing at least one of an image, audio, and video.

9. A method for a client computer coupled to a web-server via a computer network to provide a client web-browsing functionality statically partitioned between the client computer and the web-server, the method comprising:
initializing local hardware and software components;
sending an initialization request to the web-server;
establishing a browser session with the web-server corresponding to a set of web pages based on a response to the initialization request from the web-server;
receiving processed data associated with the set of web pages from web-server;
when the processed data include texts, extracting corresponding fonts from a local font library and displaying the texts on a computer screen of the client computer; and
when the processed data include geometric drawing information, regenerating corresponding geometry shapes locally on the client computer and displaying the geometry shapes on the computer screen of the client computer.

10. The method according to claim 9, further including:
when the processed data include a uniform resource locator (URL) identifying a web resource, directly loading the web resource from a server identified by the URL and displaying the web resource on the computer screen at corresponding pixel locations specified in an HTML document.

11. The method according to claim 9, wherein:
the web resource includes one of at least an image, audio, and video, and the client computer is configured to decode the web resource before displaying the web resource on the computer screen.

12. The method according to claim 9, further including:
performing an authentication with the web-server before sending out the initialization request to the web-server.

13. The method according to claim 9, further including:
capturing user input from a user of the client computer; and
sending user input information of the captured user input to the web-server for processing.

14. The method according to claim 9, further including:
transferring a file from the client computer to the web-server for storage.

15. A method for a web-server coupled to a client computer via a computer network to provide a client web-browsing functionality statically partitioned between the client computer and the web-server, the method comprising:
receiving an input from the client computer;
determining whether the input is an initialization request or a request for an existing browser session;
when the web-server determines that the input is an initialization request from the client computer, searching any stored browser session associated with the client computer;
when the web-server finds a stored browser session associated with the client computer, recovering the stored browser session such that the client computer continues from the recovered stored browser session; and
when the web-server does not find the stored browser session associated with the client computer, creating a new browser session for client computer.

16. The method according to claim 15, further including:
when the web-server determines that the input is a request for an existing browser session, determining the existing browser using a unique session ID; and
fetching page contents of a set of web pages associated with the request.

17. The method according to claim 15, further including:
when the web-server determines that the input is a file transfer request, storing or extracting a requested file to or from a dedicated storage space for the client computer.

18. The method according to claim 16, further including:
when the web-server determines that the input is a request for a read-only session, sending contents of web pages associated the existing browser session to the client computer and ignoring any further request for changing a browser state from the client computer.

19. The method according to claim 16, further including:
parsing an HTML document from the page contents;
when at least one script is embedded in the HTML document, parsing the at least one script;
creating layout information for the web page identifying geometry and location of the page contents;
when the input from the client computer contains an input event from a user of the client computer and the input event includes at least one of entering an input to one or more scripts embedded in an HTML document, and sending a new request to a web server hosting the web page, processing the input event and creating corresponding layout change information in the layout information in response to the input event from the client computer; and
sending the layout information to the client computer for rendering and display.

20. The method according to claim 19, further including:
compressing the layout information with an LZ compression algorithm before sending.

21. The method according to claim 19, further including:
executing a browser plug-in application associated with the request and invoked from the client computer; and
sending execution results and display information to the client computer.

22. The method according to claim 19, further including:
executing a non-browser plug-in application associated with the request and invoked from the client computer; and
sending execution results and display information to the client computer.
